(19) United States
(12) Patent Application Publication
(10) Pub. No.: US 2003/0115761 A1
(43) Pub. Date: Jun. 26, 2003

(54) Handsaw and method of assembling handle parts to each other and to a saw blade

(76) Inventor: Per-Olof Lofgren, Vallsta (SE)

Correspondence Address: BURNS, DOANE, SWECKER & MATHIS, L.L.P., P.O. Box 1404, Alexandria, VA, 22313-1404, US

(21) Appl. No.: 10/303,801

(22) Filed: Nov. 26, 2002

(30) Foreign Application Priority Data
Nov. 26, 2001 (SE) 0103943-7

(51) Int. Cl. B27B 21/00; B23D 51/01

(52) U.S. Cl. 30/517

(57) ABSTRACT

A handsaw includes a saw blade and a handle, wherein the handle comprises first and second handle halves. The handle halves are intended to be assembled together in connection with one end of the saw blade. The first handle half is provided with a first array of snap-elements on its inside facing the second handle half upon assembly, and the second handle half is provided with a second array of snap-elements on its respective inside facing towards the first handle half. The snap-elements of the first array engage with the snap-elements of the second array by means of a snap-action upon assembly. The handle halves are held firmly together solely through the medium of the snap-elements. Some of the snap elements may pass through holes formed in the saw blade, to secure the saw blade to the handle.

This application claims priority under 35 U.S.C. §§119 and/or 365 to Patent Application Ser. No. 0103943-7 filed in Sweden on Nov. 26, 2001, the entire content of which is hereby incorporated by reference.

### BACKGROUND OF THE INVENTION

The present invention relates to a handsaw and also to a method relating to the manufacture of a handsaw.

It is previously known to manufacture handsaws in which the handle is comprised of two halves, which are assembled around one end of the saw blade, which end is adapted therefor. Respective halves of the handle are normally joined together by welding, preferably by ultrasound welding, although they may also be joined with the aid of screws, rivets or glue. Respective halves of the handle are joined to said end of the saw blade in a corresponding manner. All of these methods require the use of some kind of ancillary equipment, such as a welding machine, screw manipulating tools, screws, rivets, riveting tools or riveting machines, glue and glue applying equipment.

The majority of modern handsaw handles are made of some type of plastic material. The present invention is particularly suited for handles of plastic material, although it is not restricted to the use of such materials.

One object of the present invention is to provide a handsaw that can offer possibilities for a simplified and less expensive method with respect to its manufacture as well as its assembly, and therewith provide a less expensive saw that, nevertheless, has sawing properties that are equally as good as those of known saws.

### SUMMARY OF INVENTION

This object and also further objects, made apparent in the following description, are achieved with a handsaw that includes a saw blade and a handle. The handle includes a first handle half and a second handle half. The handle halves are assembled together and connected with one end of the saw blade. The first handle half is provided with a first array of snap-elements on its inside which faces towards the second handle half. The second handle half is provided with a second array of snap-elements on its respective inside which faces towards the first handle half. The snap-elements of the first array engage with the snap-elements of the second array with a snap-action when assembling the handle, wherein the handle halves are fastened together solely by the snap-action of the snap-elements.

Thus, in the inventive handsaw the first handle half is provided with a first array of so-called snap-elements on its inside facing towards the second handle half when assembling the handle halves together, and the second handle half is provided with a second array of snap-elements on its respective inside facing towards the first handle half, wherein the snap-elements of the first array are designed to engage with the snap-elements in the second array with a snap-action when assembling the handle, and the handle halves may thereby be fastened together solely through the medium of said snap-action.

The inventive handsaw can thus be manufactured both simply and inexpensively. The handle halves may, for instance, be extruded in a plastic material and the handle halves and the saw blade can be assembled together with the aid of a press that functions to press the parts together and therewith bring the snap-elements into mutual engagement, in direct connection with the production line for handle halves. The production process is therefore highly efficient.

The saw components can also be stored separately prior to assembly, and assembled together only when there is a need. A handle part may, for instance, be adapted for several different saw blades and the choice of the saw blade to which the handle shall be fitted is governed by the need. Alternatively, assembly can be effected without the aid of special tools or machines. In principle, anyone is able to fit the handle and saw blade together, whenever the need arises. It is conceivable to sell the saw unassembled, or as a saw set, and allow the purchaser to fit the handle and saw blade together himself. It is obvious that this is very favorable for all parties concerned, from an economic aspect.

The method of manufacturing a handsaw that includes a saw blade and a handle, in accordance with the present invention, includes the following steps:

A) manufacturing a first handle half and a second handle half;

B) providing the first handle half with a first array of snap-elements on its inside which faces toward the second handle half, and providing the second handle half with a second array of snap-elements on its respective inside which faces towards the first handle half; and

C) assembling the handle halves together at one end of the saw blade, whereupon the snap-elements of the first array pass into engagement with the snap-elements of the second array with a snap-action, wherein the handle halves are held firmly together solely by the snap elements.

This method provides simple and highly cost-effective manufacture of handsaws.

The snap-elements may, of course, have any one of many different designs, the majority of which are known per se. According to one embodiment, half of the snap-elements include snap-devices in the form of at least one shoulder, while the other half of the snap-elements include snap-devices in the form of at least one groove or slot. Other solutions are possible, for instance a solution in which two shoulders or hooks mutually co-act. It is normally required that the snap-elements be somewhat resilient, which is preferably achieved by the choice of an appropriate plastic material, which can be selected by the skilled person.

According to one preferred embodiment, the snap-elements have the form of mutually co-acting male and female elements, where a male element on one handle half co-acts with a corresponding female element on the other handle half. One of the handle halves may be provided solely with male elements and the other half provided with solely female elements. Alternatively, each of the handle halves may include both male and female elements.

According to the preferred embodiment, both male and female elements have a cylindrical shape and either the male or the female elements may have at least one shoulder disposed on its outside or inside, respectively, this shoulder being intended for co-action with at least one groove disposed on the inside of a co-acting female element or the outside of a co-acting male element, respectively, to provide said snap action.

According to one particularly preferred embodiment, the male and female elements have the form of hollow cylinders which mutually co-act in pairs, wherein the cylinder that forms a male element has an external diameter that is at most equal to the internal diameter of the cylinder that forms a corresponding female element. The provision of snap-elements in the form of hollow cylinders affords advantages from the aspect of production, when the handle halves are made of plastic and when it is important to have an adequate clearance.

According to one beneficial feature of the invention, at least part of the snap-elements are designed so that they will also function as securing means for the saw blade. In this regard, the saw blade is provided with holes at that end onto which the handle shall be fitted, wherein the holes are designed to allow at least a part of the snap-elements in at least one of said arrays of snap-elements to pass therethrough. One advantage thus provided is that the snap-elements can have a double function and obviate the need for special elements for securing the saw blade. Alternatively, however, it is fully conceivable for the saw blade to be fastened to the handle in a conventional manner, for instance with the aid of screws or glue.

According to a further beneficial feature of the invention, at least one of the handle halves includes, on its inside, stop members for stopping any movement of the saw blade in a direction towards a hand gripping the handle. These stop members are comprised beneficially, and at least partially, of snap-elements that are not used to secure the saw blade.

Further features and advantages will be apparent from the remaining dependent claims.

### BRIEF DESCRIPTION OF DRAWINGS

The invention will now be described in more detail with reference to a non-limiting embodiment illustrated in the accompanying schematic drawings, in which:

FIG. 1 is a schematic partial view in perspective taken from one side of an assembled handsaw in accordance with the present invention.

FIG. 2 is a perspective partial view, from above, of a first handle half and parts of a saw blade comprised in a handsaw in accordance with the present invention.

FIG. 3 is a perspective view, from above, of a second handle half comprised in a handsaw in accordance with the present invention.

### DESCRIPTION OF A PREFERRED EMBODIMENT OF THE INVENTION

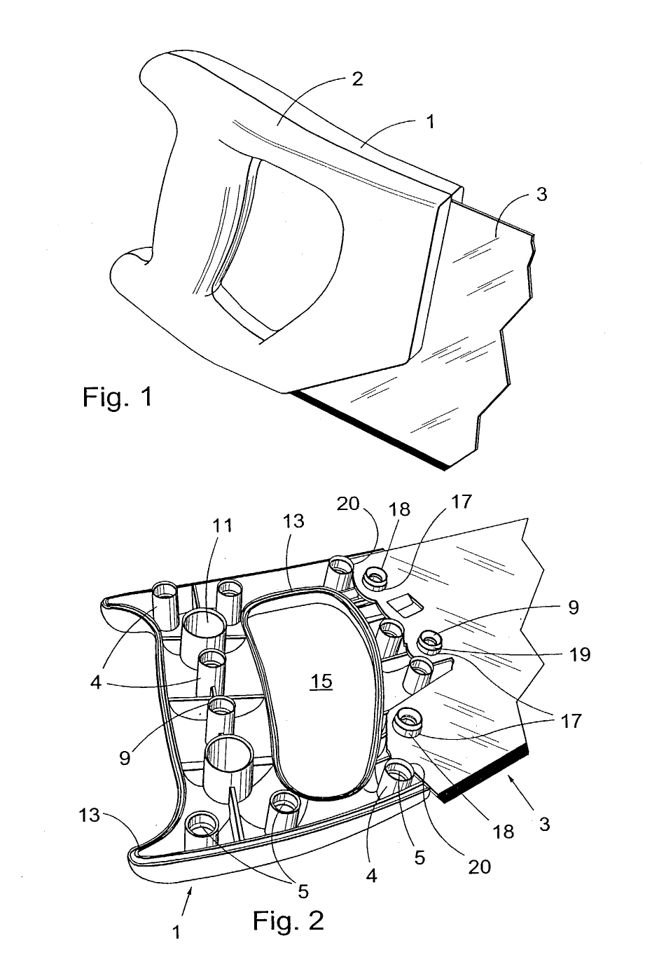

FIG. 1 shows a partial view of a handsaw according to one embodiment of the present invention. The handsaw comprises a handle and a saw blade. The handle comprises two halves 1, 2, which are fitted together around one end of the saw blade 3. The handle halves are preferably extruded from plastic material, or may be produced in some other suitable manner.

The illustrated handsaw is of the kind that includes an opening 15 for accommodating the fingers of one hand. However, the invention is not restricted to a saw that includes this type of handle, but may also be used in saws in which the handle is designed with a grip part around which the hand grasps and with which the saw blade is affixed at the upper part of the grip part, such as in the case of gardening saws or pruning saws, or other types of handles.

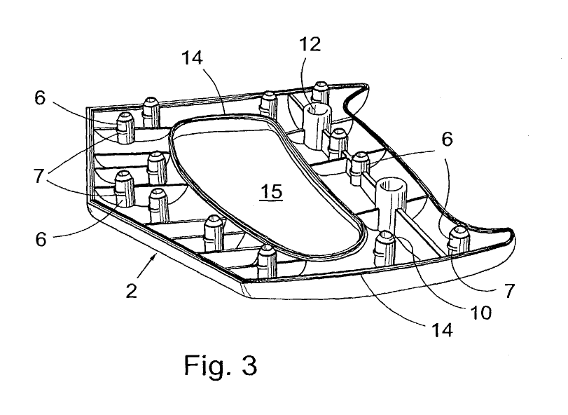

FIG. 2 illustrates a first handle half 1 and parts of the saw blade 3, in accordance with the present invention. The handle half is provided on its inside, i.e. the side that is intended to face towards and be joined to the second handle half 2 when assembling the handle, with a number of hollow symmetrical projections 4. These projections form so-called snap-elements which are designed to co-act with corresponding snap-elements 6 on the second handle half 2, shown in FIG. 3. In the illustrated embodiment, the snap-elements 4 of the first handle half 1 form female snap-elements, whereas the snap-elements 6 on the second handle half 2 form male snap-elements.

When assembling the handle, the male elements 6 enter and engage with the female elements 4 by means of a snap-in action. The snap-in action is primarily achieved by providing each female element 4 with at least one groove 5 on its inside. This groove 5 is adapted to co-act with a shoulder or a projection 7 disposed on the outside of a corresponding male element 6. Because the various parts are somewhat resilient, e.g., as a result of a suitable choice of plastic material, the shoulder engages the groove through a so-called snap-in effect when assembling the handle. A vice versa arrangement with respect to the shoulders and the grooves would naturally also be feasible, i.e., the grooves formed on the male elements.

The inside of the female elements 4 preferably have a beveled upper edge 9, to facilitate insertion of the male element 6 and also to assist in guiding said elements. The male elements will also preferably have a beveled upper edge 10, although beveled on the external side.

It should be mentioned that the male elements are shown as hollow, but may well consist of solid bodies, by way of an alternative.

Advantageously, the two handle halves also include guide elements in the form of hollow cylinders 11,12 that are inserted into one another when assembling the handle. The handle halves may also include guide elements in the form of a lip or rebate 13 and 14 along the outer edges of the respective handle halves, with the exception of the edge side where the saw blade is fitted. A guide element in the form of a lip or rebate may also be provided around the finger-grip opening 15.

The saw blade 3 includes a plurality of holes 17 at the end that is intended to be fitted together with the handle halves 1, 2. These holes are adapted to be fitted over and held firmly around certain ones 18 of the snap-elements in one of the handle halves. These snap-elements 18 thus also function as securing devices for the saw blade.

The holes 17 in the saw blade are therefore arranged in accordance with a pattern that corresponds to a pattern formed by given snap-elements 18 that are to be used as saw blade securing devices. In the case of the illustrated example, some of the female elements are also used as blade securing devices. This is beneficial, as it facilitates assembly. In order to further facilitate fitting of the saw blade over the combined snap-elements/securing devices 18, said elements 18 are conveniently provided with guide means in the form of a slight bevel 19 also on the outside of their respective upper edges. This guide means may also be configured so that said elements have a conical shape, which extends from the upper edge and down to the location of the saw blade.

The design of the end of the saw blade and the placement of the snap-elements in this part of the handle half is adapted so that some of the snap-elements 20, normally those that do not form blade securing devices, also function as saw blade stop members. By stop members is meant members that are situated so as to prevent any rotational movement of the saw blade in relation to the handle or movement of the saw blade towards the grip opening 15 in which the gripping hand is situated. Thus, the intention is that said stop members shall function as a protection against injury to the hand, should the saw blade come free from the blade securing devices for some reason or another and be pressed in a direction towards the grip opening. At least parts of the edge of the saw blade end will conveniently abut against the stop members subsequent to assembly, although the stop members will also fulfil their intended function should there be a gap between said edge and said stop members. It is preferred also in this case that certain of the female elements fulfil this function.

In assembly, the holes 17 provided in said one end of the saw blade 3 are placed over corresponding snap-elements/blade securing devices 4/18 of the one handle half 1. The two handle halves 1, 2 are then pressed together around said end of the saw blade, so that the male snap-elements 6 enter the female snap-elements 4 and so that the shoulders 7 on the male snap-elements engage with the grooves 5 within the female snap-elements. This results in a snap-fix action, which holds the handle halves and the saw blade securely together in a convenient and satisfactory manner. It can be mentioned that the shoulders and the grooves of respective snap-elements are situated so that it is necessary to press the handle halves further together, so as to bring the grooves 5 and shoulders 7 of respective snap-elements 4, 6 into positive engagement with each other, subsequent to having brought the handle halves into a position in which they abut one another. This results in biasing or pre-stressing of the snap-elements such as to counteract the occurrence of gaps. As earlier mentioned, it is necessary that the material, from which the handle is made, will allow a certain degree of resilience in the parts, in order for this to be achieved.

As the blade-securing male elements 18 are pressed into the female elements, these female elements are pressed slightly outwards so as to obtain a biasing or pre-stressing of the saw blade 3 around the female element. This biasing action means that the saw blade is unable to slide axially along the cylindrical snap-elements, but is held securely instead.

It will be understood that the present invention is not restricted to the illustrated examples thereof, and that variations and modifications can be made in numerous ways, within the scope of the accompanying claims, as will be realized by those skilled in the art.

What is claimed is:

1. A handsaw comprising a saw blade and a handle which includes a first handle half and a second handle half, said handle halves being assembled together and connected with one end of the saw blade, wherein the first handle half is provided with a first array of snap-elements on its inside which faces towards the second handle half, the second handle half provided with a second array of snap-elements on its respective inside which faces towards the first handle half, wherein the snap-elements of the first array engage with the snap-elements of the second array with a snap-action when assembling the handle, wherein the handle halves are fastened together solely by the snap-action of the snap-elements.

2. A handsaw according to claim 1, wherein half of the snap-elements include snap-devices in the form of at least one shoulder, and the other half of the snap-elements include snap devices in the form of at least one groove for receiving the shoulder.

3. A handsaw according to claim 1, wherein one of said arrays includes snap-elements provided with snap-devices on its inside, and the other array includes snap-elements provided with snap-devices on its outside.

4. A handsaw according to claim 1, wherein the snap-elements have the form of mutually co-acting male and female elements, such that a male element on one handle half co-acts with a corresponding female element on the other handle half.

5. A handsaw according to claim 4, wherein one of the handle halves is provided with solely male elements, and the other handle half is provided with solely female elements.

6. A handsaw according to claim 4, wherein each of said handle halves is provided with both male elements and female elements.

7. A handsaw according to claim 4, wherein both the male elements and the female elements have a cylindrical shape and that either the male elements or the female elements include at least one shoulder on its outside or its inside, respectively, wherein said shoulder is adapted for co-action with at least one groove provided on the inside of a co-acting female element or on the outside of a co-acting male element, respectively, such as to provide said snap-action.

8. A handsaw according to claim 7, wherein one of the handle halves is provided with solely male elements, and the other handle half is provided with solely female elements.

9. A handsaw according to claim 7, wherein each of said handle halves is provided with both male elements and female elements.

10. A handsaw according to claim 4, wherein both male and female elements have the form of hollow cylinders which mutually co-act in pairs, and wherein the cylinder that forms a male element has an outer diameter which at most is equal to the internal diameter of the cylinder that forms the corresponding female element.

11. A handsaw according to claim 1, wherein each handle half includes an opening into which a user's fingers can be inserted, and said snap-elements are disposed on respective sides of said opening.

12. A handsaw according to claim 1, wherein at least some of the snap-elements engage and secure the saw blade to the handle.

13. A handsaw according to claim 12, wherein at least some of the snap-elements in at least one of the snap-element arrays pass through holes formed in the one blade end.

14. A handsaw according to claim 12, wherein at least one of the handle halves includes, on its inside, at least one safety stop member arranged for stopping movement of the saw blade in a direction towards a user's hand gripping said handle.

15. A handsaw according to claim 14, wherein at least portions of a side edge of the one end of the blade abut the stop members subsequent to assembly of the handle to the blade.

16. A handsaw according to claim 15, wherein said stop members are comprised at least partially of snap-elements that are not used to secure the saw blade.

17. A method of producing a handsaw that includes a saw blade and a handle, said method including the following steps:
A) manufacturing a first handle half and a second handle half;
B) providing the first handle half with a first array of snap-elements on its inside which faces towards the second handle half, and providing the second handle half with a second array of snap-elements on its respective inside which faces towards the first handle half; and
C) assembling the handle halves together at one end of the saw blade, whereupon the snap-elements of the first array pass into engagement with the snap-elements of the second array with a snap-action, wherein the handle halves being held firmly together solely by the snap-action of the snap-elements.

18. A method according to claim 17, including the step of providing holes in the one end of the saw blade, step C including inserting at least some of the snap-elements in at least one of said arrays through respective holes.
